(19) United States
(12) Patent Application Publication
(10) Pub. No.: US 2024/0055596 A1
(43) Pub. Date: Feb. 15, 2024

(54) COATED NICKEL-RICH LAYERED OXIDE ELECTRODES AND APPLICATIONS THEREOF

(71) Applicant: THE BOARD OF TRUSTEES OF THE UNIVERSITY OF ARKANSAS, Little Rock, AR (US)

(72) Inventors: Xiangbo MENG, Fayetteville, AR (US); Xin WANG, Fayetteville, AR (US)

(21) Appl. No.: 18/267,829

(22) PCT Filed: Dec. 15, 2021
(86) PCT No.: PCT/US2021/063517

§ 371 Date: Jun. 16, 2023

Related U.S. Application Data
(60) Provisional application No. 63/127,481, filed on Dec. 18, 2020.

(51) Int. Cl. H01M 4/525; H01M 4/505; H01M 4/04; H01M 4/58; H01M 10/052

(52) U.S. Cl. CPC H01M 4/525; H01M 4/505; H01M 4/0428; H01M 4/5815; H01M 10/052; H01M 2004/028

(57) ABSTRACT

Nickel-rich layered oxide electrodes are described herein having high conductivity coatings which, in some embodiments, mitigate degradative pathways, maintain electrode performance and enhance electrode lifetimes. In one aspect, an electrode comprises nickel-rich layered oxide, and a sulfide-based coating or oxide-based coating over the nickel-rich layered oxide, the sulfide-based or oxide-based coating having an ionic conductivity greater than 1×10⁻⁴ S/cm at room temperature. In some embodiments, the ionic conductivity is at least 1×10⁻³ S/cm at room temperature. Moreover, the sulfide-based coating can comprise a ternary sulfide, the ternary sulfide comprising lithium and aluminum.

### CROSS REFERENCE TO RELATED APPLICATIONS

The present application claims priority to U.S. Provisional Application Ser. No. 63/127,481, filed Dec. 18, 2020, the contents and substance of which are incorporated herein in its entirety by reference.

### STATEMENT OF GOVERNMENT INTEREST

This invention was made with government support under Federal Grant No. OIA1457888 awarded by the National Science Foundation (NSF). The government has certain rights to this invention.

### FIELD

The present application relates to nickel-rich layered oxide electrodes and, in particular, to such electrodes comprising ionically conductive coatings operable to maintain electrode performance and/or enhance electrode lifetimes.

### BACKGROUND

Currently, transportation is consuming ˜30% of the total energy in the United States, while petroleum supplies over 90% of energy needs of transportation. To deal with the ever-aggravating depletion of fossil fuels and environmental issues, transportation electrification represents a renewable clean solution. To date, however, the market share of battery-powered electric vehicles (BEVs) is still very low, less than 3%. To boost the market share of BEVs, state-of-the-art lithium-ion batteries (LIBs) have become insufficient in multiple aspects and next-generation robust LIBs are urgently needed to meet the following requirements: a high energy density of ≥300 Wh/kg for a driving range of ≥300 miles, affordable cost (≤$125/kWh), reliable safety free of fires and explosions, and long lifetime of ≥15 calendar years.

In pursuing high energy LIBs, cathode materials play a crucial role in the whole battery cell system, including working voltage, specific capacity, energy and power density, cycle life, and safety. Currently, the cathodes available for BEVs are spinel LiMn₂O₄ (LMO), olivine LiFePO₄ (LFP), layered LiCoO₂ (LCO), layered LiNi_{0.8}Co_{0.15}Al_{0.05}O₂ (NCA), and layered LiNiₓ Mn_{y}Co_{z}O₂ (NMC, x+y+z=1). Among all the available cathode materials, NMC cathodes are among the most promising candidates, as illustrated in FIG. 1.

With the increasing Ni content, NMC cathodes enable higher capacities, such as NMC811. However, it becomes more challenging for commercialization, due to their lower capacity retention and lower thermal stability (see FIG. 2). The issues of NMC811 are exhibited in two aspects: (1) performance degradation and (2) safety hazard. These two challenges are closely related to the high Ni content of 80%, which leads to the structural, interfacial, and thermodynamic instability of NMC811 during cycling.

### SUMMARY

In view of these disadvantages, nickel-rich layered oxide electrodes are described herein having high ionic conductivity coatings which, in some embodiments, mitigate degradative pathways, maintain electrode performance and/or enhance electrode lifetimes. In one aspect, an electrode comprises nickel-rich layered oxide, and a lithium-containing sulfide or oxide coating over the nickel-rich layered oxide, the lithium-containing sulfide (or oxide) coating having an ionic conductivity from 1×10⁻⁶ S/cm to 9×10⁻² S/cm at room temperature. In some embodiments, the ionic conductivity is tunable within this range. Moreover, the lithium-containing sulfide and/or oxide coatings can be binary or ternary. Ternary sulfides and/or oxides, for example, comprise lithium and another metal, including aluminum, zinc, gallium, and/or zirconium. In another aspect, an electrode described herein comprises nickel-rich layered oxide, and a lithium-containing coating over the nickel-rich layered oxide.

Turning now to specific components, the ternary sulfides of the coatings can be of the formula LiₚMₙ₍₂₋ₚ₎S, wherein 0<p≤2, 0.25≤n≤0.5, M=Al, Zn, Ga, and Zr. The ternary oxides of the coatings can be of the formula LiₚMₙ₍₂₋ₚ₎O, wherein 0<p≤2, 0.25≤n≤0.5, M=Al, Zn, Ga, and Zr. The binary sulfide is Li₂S. The lithium-containing coatings can have any thickness not inconsistent with the technical objectives described herein relative to enhancing and/or maintaining performance of nickel-rich layered oxide electrodes. In some embodiments, the lithium-containing coatings have thickness of 1 nm to 10 nm. Alternatively, the lithium-containing coating can have thickness less than 1 nm or greater than 10 nm, in some embodiments. Additionally, the lithium-containing coatings can exhibit uniform thickness, in some embodiments. As described further herein, the lithium-containing coatings can be deposited over the nickel-rich layered oxide via atomic layer deposition (ALD).

The nickel-rich layered oxide, in some embodiments, can be of the formula LiNi_{1-x-y}MnₓCo_{y}O₂, wherein 1−x−y≥0.6. In some embodiments, 1−x−y≥0.7 or 1−x−y≥0.8.

In another aspect, batteries are described herein. A battery comprises an anode, and a cathode, the cathode including nickel-rich layered oxide, and a lithium-containing coating over the nickel-rich layered oxide, the lithium-containing coating having an ionic conductivity ranging from 1×10⁻⁶ S/cm to 9×10⁻² S/cm at room temperature. The lithium-containing coatings can have any composition and/or properties described herein. Additionally, the nickel-rich layered oxide can have any compositions and/or properties described herein. Moreover, batteries having the foregoing constructions can be employed in electric vehicles.

In a further aspect, methods of making electrodes are described herein. In some embodiments, a method of making an electrode comprises providing an electrode substrate comprising nickel-rich layered oxide, and depositing a lithium-containing coating over the nickel-rich layered oxide. The lithium-containing coatings can have an ionic conductivity greater than 1×10⁻⁴ S/cm at room temperature. In some embodiments, the ionic conductivity of the sulfide-based coating is at least 1×10⁻³ S/cm at room temperature. The lithium-containing coatings and nickel-rich layered oxide can have any composition and/or properties described herein. In some embodiments, the lithium-containing coatings are deposited by atomic layer deposition. As described further herein, the atomic layer deposition can comprise individual sub-cycles of Li—S and M-S (M=Al, Zn, Ga, and Zr) in any sub-cycle ratio. In some embodiments, a ratio of Li—S to M-S sub-cycles ranges from 1:10 to 10:1. For example, the ratio of Li—S to Al—S sub-cycles can be 1:4, in some embodiments.

These and other embodiments are further described in the following detailed description.

### BRIEF DESCRIPTION OF THE DRAWINGS

FIG. 1 illustrates performance characteristics of electrodes of various construction, according to some embodiments.

FIG. 2 illustrates performance characteristics of various NMC electrodes, according to some embodiments.

FIG. 3a illustrates performance characteristics of NMC811 cathodes coated with low conductivity LAS coatings.

FIG. 3b illustrates performance characteristics of NMC811 cathodes coated with high conductivity LAS coatings, according to some embodiments.

FIGS. 3c and 3d illustrate cyclability of NMC811 cathodes coated with sulfide-based coatings described herein relative to bare NMC811 cathodes, according to some embodiments.

FIGS. 4a and 4b provide charge-discharge profiles with normalized capacity of bare and sulfide coated NMC811 cathodes respectively, according to some embodiments.

FIGS. 5a and 5b are schematics illustrating uncoated and coated NMC electrodes respectively, according to some embodiments.

FIG. 6 illustrates performance characteristics of NMC811 cathodes coated with Li₂S coatings, according to some embodiments.

FIG. 7 illustrates performance characteristics of NMC811 cathodes coated with 1:1 LiₓZr_{y}O coatings, according to some embodiments.

FIGS. 8a and 8b illustrates the tunable synthesis strategy of ALD and the resultant tunable composition of LiₓM_{y}S (M=Al, Zn, Ga, and Zr) via ALD, respectively.

FIG. 9a illustrates the linear growth characteristic of LiₓZn_{y}S at different sub-cycle ratios of Li—S:Zn—S, measured by quartz crystal microbalance (QCM). FIG. 9b illustrates the linear growth of LiₓZn_{y}S at the 1:1 sub-cycle ratio of Li—S:Zn—S.

FIG. 10a illustrates the linear growth characteristic of LiₓZr_{y}S at different sub-cycle ratios of Li—S:Zr—S, measured by quartz crystal microbalance (QCM). FIG. 10b illustrates the linear growth of LiₓZr_{y}S at the 1:1 sub-cycle ratio of Li—S:Zr—S.

FIG. 11a illustrates the time-resolved mass change profile of ALD ZrS₂ films at 150° C. FIG. 11b compares the growth profiles of 100-cycle ALD ZrS₂ films at various deposition temperatures. FIG. 11c summarizes the growth rate of ALD ZrS₂ films in the range of 75-300° C. FIG. 11d shows an enlarged view of the mass change for three ALD cycles at 150° C.

FIGS. 12a and 12b illustrate the linear growth of LiₓZr_{y}O with a 1:1 sub-cycle ratio of Li—O:Zr—O at 225° C. FIGS. 12c and 12d illustrate the linear growth of LiₓZr_{y}O with a 1:2 sub-cycle ratio of Li—O:Zr—O at 225° C.

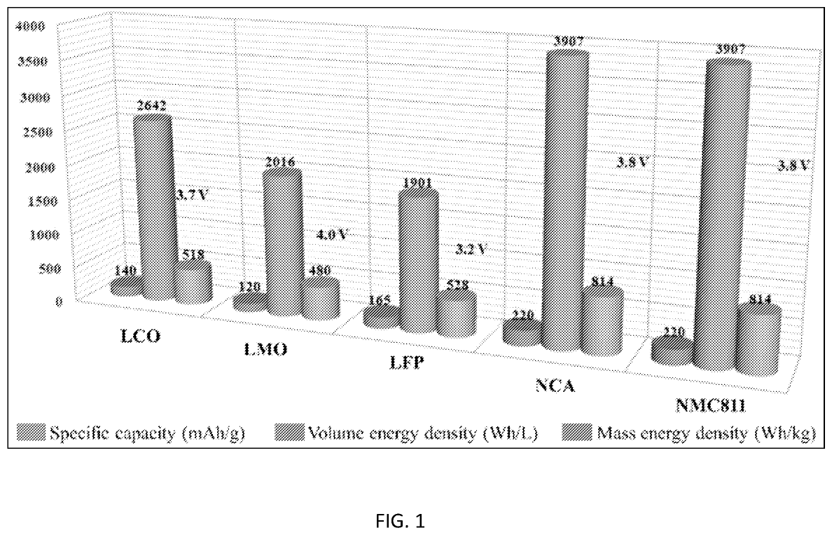

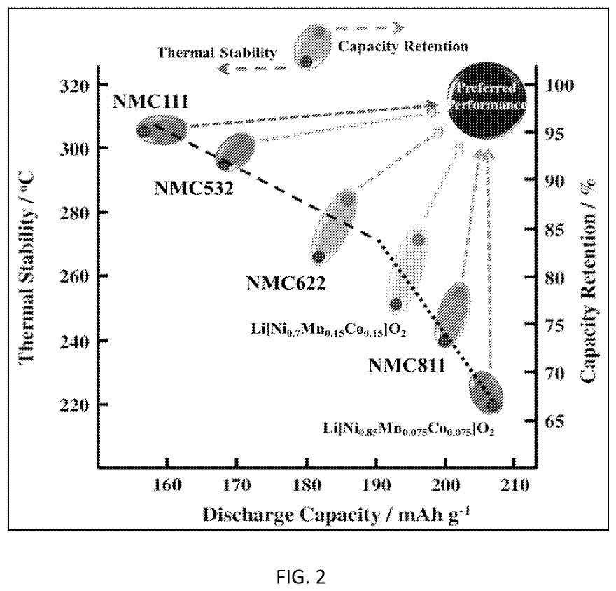

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

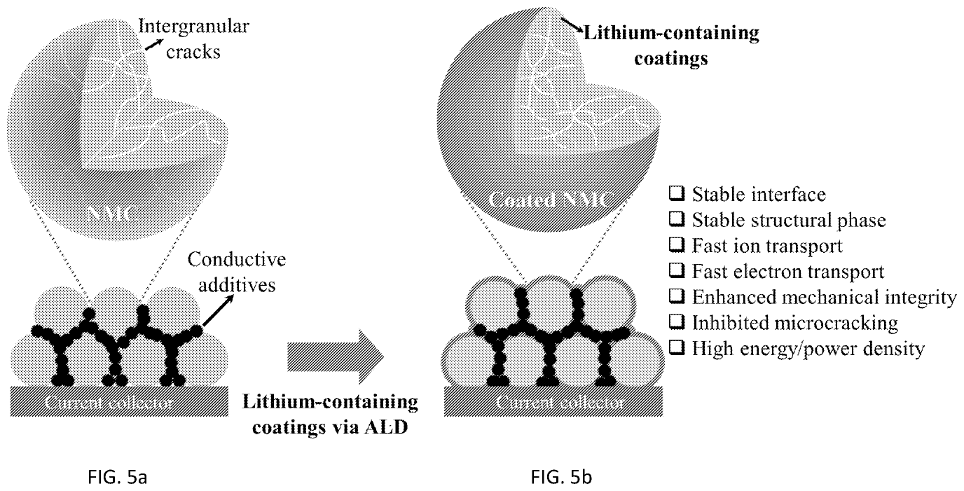

As set forth in the following data, the lithium-containing coatings comprising Li₂S, LiₓAl_{y}S, LiₓZn_{y}S, LiₓGa_{y}S, LiₓZr_{y}S, or LiₓZr_{y}O can provide several unique benefits to electrodes constructed of nickel-rich layer oxides, including NMC811. These benefits include, but are not limited to:
(1) Forming a fully conformal networked coverage of a superionic conductor over the whole NMC811 electrodes with highly adjustable film thickness to achieve desirable mechanical integrity
(2) Effectively inhibiting intergranular and intragranular microcracking
(3) Effectively inhibiting NMC phase transition and oxygen evolution
(4) Serving as a stable superionic conducting interface enabling fast ion transport and mitigating parasitic reactions
(5) Solidifying the pathways of electrons, which are established by conductive additives
(6) Washing residual lithium compounds away from NMC811 surface.
   FIGS. 5a and 5b are schematics illustrating uncoated and coated NMC electrodes respectively, according to some embodiments.

### Various Non-Limiting Embodiments

Some additional, non-limiting, example embodiments are provided below.

Embodiment 1. An electrode comprising: nickel-rich layered oxide; and
a sulfide-based or oxide-based coating over the nickel-rich layered oxide, the sulfide- or oxide-based coating having an ionic conductivity greater than 1×10⁻⁴ S/cm at room temperature.

Embodiment 2. The electrode of Embodiment 1, wherein the ionic conductivity is at least 1×10⁻³ S/cm at room temperature.

Embodiment 3. The electrode of Embodiment 1, wherein the sulfide-based coating comprises a ternary sulfide, the ternary sulfide including lithium and aluminum, lithium and zinc, lithium and gallium, or lithium and zirconium.

Embodiment 4. The electrode of Embodiment 1, wherein the sulfide-based coating has a uniform thickness.

Embodiment 5. The electrode of Embodiment 4, wherein the thickness is from 1 nm to 10 nm.

Embodiment 6. The electrode of Embodiment 1, wherein the nickel-rich layered oxide is of the formula LiNi_{1-x-y}MnₓCo_{y}O₂, wherein 1−x−y≥0.6.

Embodiment 7. The electrode of Embodiment 6, wherein 1−x−y≥0.7.

Embodiment 8. The electrode of Embodiment 6, wherein 1−x−y≥0.8.

Embodiment 9. The electrode of Embodiment 3, wherein the ternary sulfide is of the formula LiₚMₙ₍₂₋ₚ₎S, wherein 0<p≤2, 0.25≤n≤0.5.

Embodiment 10. The electrode of Embodiment 1, wherein the sulfide-based coating is deposited by atomic layer deposition.

Embodiment 11. An electrode comprising:
nickel-rich layered oxide; and
a ternary sulfide-based coating over the nickel-rich layered oxide.

Embodiment 12. The electrode of Embodiment 11, wherein the ternary sulfide-based layer includes lithium and aluminum, lithium and zinc, lithium and gallium, or lithium and zirconium.

Embodiment 13. The electrode of Embodiment 11, wherein the ternary sulfide is of the formula LiₚMₙ₍₂₋ₚ₎S, wherein 0<p≤2, 0.25≤n≤0.5.

Embodiment 14. The electrode of Embodiment 11, wherein the ternary sulfide based layer has ionic conductivity greater than 1×10⁻⁴ S/cm at room temperature.

Embodiment 15. The electrode of Embodiment 14, wherein the ionic conductivity is at least 1×10⁻³ S/cm at room temperature.

Embodiment 16. The electrode of Embodiment 11, wherein the ternary sulfide-based coating has thickness of 1 nm to 10 nm.

Embodiment 17. The electrode of Embodiment 11, wherein the nickel-rich layered oxide is of the formula LiNi_{1-x-y}MnₓCo_{y}O₂, wherein 1−x−y≥0.6.

Embodiment 18. The electrode of Embodiment 17, wherein 1−x−y>0.7.

Embodiment 19. The electrode of Embodiment 17, wherein 1−x−y≥0.8.

Embodiment 20. A battery comprising:
an anode; and
a cathode, the cathode comprising the electrode as in any one of Embodiments 1-19.

Embodiment 21. An electric vehicle comprising:
at least one battery comprising an anode and a cathode, the cathode comprising the electrode as in any one of Embodiments 1-19.

Embodiment 22. A method of making an electrode comprising:
providing an electrode substrate comprising nickel-rich layered oxide; and
depositing a sulfide-based lithium-containing coating over the nickel-rich layered oxide, the lithium-containing coating having an ionic conductivity greater than 1×10⁻¹⁰ S/cm at room temperature.

Embodiment 23. The method of Embodiment 22, wherein the ionic conductivity is at least 1×10⁻³ S/cm at room temperature.

Embodiment 24. The method of Embodiment 22, wherein the sulfide-based lithium-containing coating comprises a ternary sulfide, the ternary sulfide including lithium and aluminum, lithium and zinc, lithium and gallium, or lithium and zirconium.

Embodiment 25. The method of Embodiment 22, wherein the sulfide-based lithium-containing coating is deposited by atomic layer deposition.

Embodiment 26. The method of Embodiment 25, wherein the atomic layer deposition comprises individual sub-cycles of Li—S and Al—S, individual sub-cycles of Li—S and Zn—S, individual sub-cycles of Li—S and Ga—S, or individual sub-cycles of Li—S and Zr—S.

Embodiment 27. The method of Embodiment 26, wherein a ratio of Li—S to M-S (M=Al, Zn, Ga, and Zr) sub-cycles ranges from 1:10 to 10:1. More particularly, Embodiment 27 describes an implementation wherein the ratio of Li—S to Al—S, Zn—S, Ga—S, or Zr—S used in the individual sub-cycles ranges from 1:10 to 10:1.

Embodiment 28. The method of Embodiment 27, wherein the ratio is 1:4.

Embodiment 29. The method of Embodiment 27, wherein the sulfide-based lithium-containing coating is of the formula LiₚAl_{(2-p)/3}S and LiₚGa_{(2-p)/3}S, the formula of LiₚZn_{(1-p/2)}S and the formula of LiₚZr_{(0.5-0.25p)}S, wherein 0<p≤2, 0.25≤n≤0.5

Embodiment 30. The method of Embodiment 22, wherein the nickel-rich layered oxide is of the formula LiNi_{1-x-y}MnₓCo_{y}O₂, wherein 1−x−y≥0.6.

Embodiment 31. The method of Embodiment 30, wherein 1−x−y>0.7.

Embodiment 32. The method of Embodiment 30, wherein 1−x−y≥0.8.

### Examples

The present examples provide aspects of embodiments of the present disclosure. These examples are not meant to limit embodiments solely to such examples herein, but rather to illustrate some possible implementations.

A comparative study using a 1:1 LiₓAl_{y}S (which is deposited with a 1:1 sub-cycle ratio of Li—S:Al—S via ALD, named as LAS) of low conductivity (6.7×10⁻⁷ S/cm at room temperature) and the 1:4 LiₓAl_{y}S coating (which is deposited with a 1:4 sub-cycle ratio of Li—S:Al—S via ALD, named as sup-LAS having conductivity of at least 1×10⁻⁴ S/cm at room temperature) to modify NMC811 electrodes. NMC811 electrodes were coated by the two coatings with different thicknesses, 20 (˜2 nm), 40 (˜4 nm), and 80 (˜8 nm) ALD cycles. The resultant LAS-coated electrodes were signified as LAS20, LAS40, and LAS80, while the resultant sup-LAS-coated electrodes were named as sup-LAS20, sup-LAS40, and sup-LAS80, respectively. The LAS and sup-LAS coated electrodes were tested for their rate capability at different current densities (0.1, 0.2, 0.5, 1, 2, 5, 7, and 0.5C) and compared to the performance of bare NMC811 electrodes in the voltage range of 3.0-4.5 V at RT. 1C is equal to 200 mA/g.

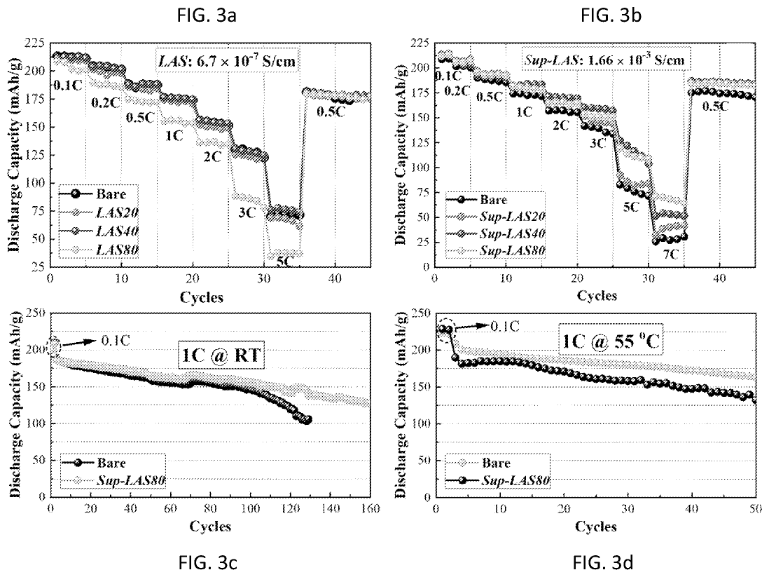

Experimental results revealed that, as shown in FIG. 3a, the LAS coating with low conductivity could not improve the performance of NMC811. It is particularly evident that the LAS80 electrode has much lower capacities than those of the bare NMC811 electrode at all the rates from 0.1 to 5C. It is worth noting that the higher the rate, the worse the capacity of the LAS80 electrode.

In contrast, the sup-LAS coating improved the performance of NMC811 electrodes. As shown in FIG. 3b, the sup-LAS electrodes did not exhibit remarkable improvements at low rates (0.1 and 0.2 C). Very impressively, the sup-LAS coatings performed much better at higher rates with thicker thicknesses. For instance, both sup-LAS40 and sup-LAS80 electrodes exhibited a comparable discharge capacity of 125 mAh/g at 5C, ˜50 mAh/g higher than that of the bare NMC811 electrode. At 7C, the sup-LAS80 electrode enabled a capacity of ˜70 mAh/g, around 3 times higher than that of the bare NMC811 electrode.

The effects of the sup-LAS coating were further tested on cyclability of NMC811 electrodes at 1C at room temperature and an elevated temperature of 55° C. As illustrated in FIG. 3c, the sup-LAS80 electrode performed much better than the bare NMC811 electrode in cyclability. The former could still run with a decent capacity of 125 mAh/g at 1C after 160 cycles while the latter has exhibited quick capacity fading after 100 cycles at RT. At 55° C., as shown in FIG. 3d, the benefits of the sup-LAS coating were even more evident and the sup-LAS80 electrode shows higher capacity and better cyclability in 50 cycles at 1C.

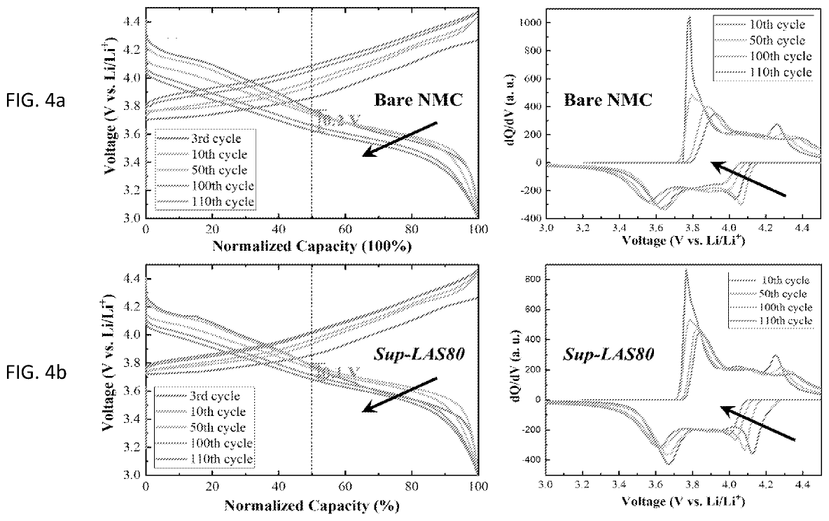

Normalizing the data in FIG. 3c, the normalized charge-discharge profiles (see FIGS. 4a and 4b) revealed that the bare NMC811 has larger voltage drop than that of the sup-LAS80 electrode, i.e., 0.2V versus 0.1V after 110 cycles. In other words, the sup-LAS coating has mitigated the structure degradation of the NMC811 cathode with less voltage drop. Furthermore, through analyzing differential capacity, as shown in FIGS. 4c and 4d, we can observe the evolutions of characteristic peaks with cycles. All these electrochemical testing and analyses confirmed that the proposed invention is feasible and shows tremendous impacts on improving the performance of NMC811 cathodes. This invention has great potential to be commercialized.

All these results of the sup-LAS coating are very encouraging and have not been reported in previous studies. In particular, the sup-LAS-coated NMC811 cathodes showed better performance with thicker sup-LAS coatings in the tested film thicknesses. This confirmed that the sup-LAS coating has excellent ionic conductivity. Furthermore, these results demonstrated that the sup-LAS coating has great potentials to change our traditional choices on coating materials, ascribed to its exceptional ionic conductivity of ˜10⁻³ S/cm at RT. To this end, it becomes very critical to thoroughly reveal the effects of the sup-LAS coating and fully explore the underlying mechanisms.

Based on these preliminary data, it is believed that, compared to the coatings practiced previously, the ALD sup-LAS coating potentially has several novel benefits not realized previously:
(1) Provide faster ion transportation. This is determined by the superionic conducting nature of the sup-LAS coating. This has made possible for fast charging (FIG. 3b). This is very significant for BEVs.
(2) Provide better structural, interfacial, and thermodynamic stability. Due to its superionic conducting characteristic, the sup-LAS coating could form a full coverage with large thickness (e.g., 8 nm) but did not reduce ion transportation rate remarkably. This thick coating helps sustain better structural, interfacial, and thermodynamic stability of NMC811 electrodes.
(3) Provide better mechanical properties. The full and thick coverage of the sup-LAS coating could readily offer better mechanical properties to NMC811 electrodes. This benefits the electrodes in multiple aspects such as good contact and cracking reduction.

With these benefits, we expect that the sup-LAS coating would provide new solutions to the existing challenges in LIBs and this may pave a new technical venue for researchers to tackle issues associated with NMC811 cathodes. It will also be particularly significant to explore the underlying mechanisms responsible for the beneficial effects of the sup-LAS coating.

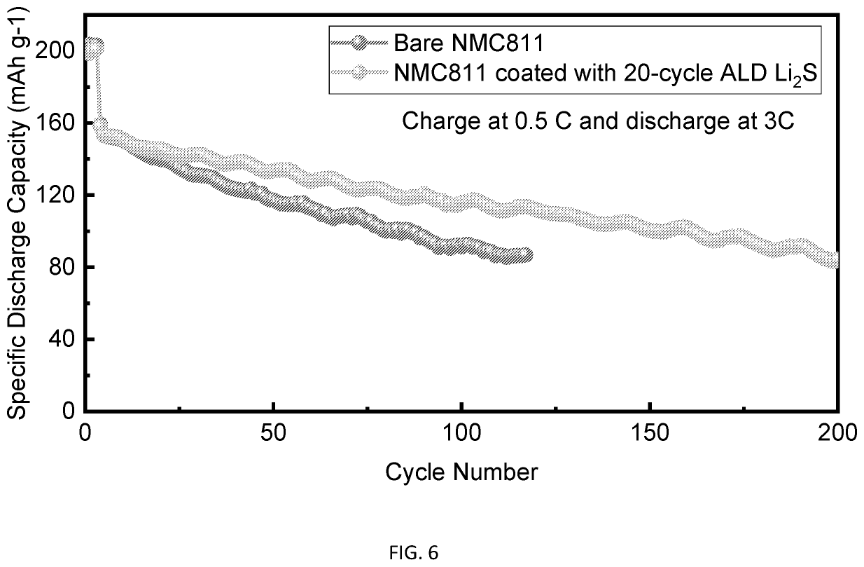

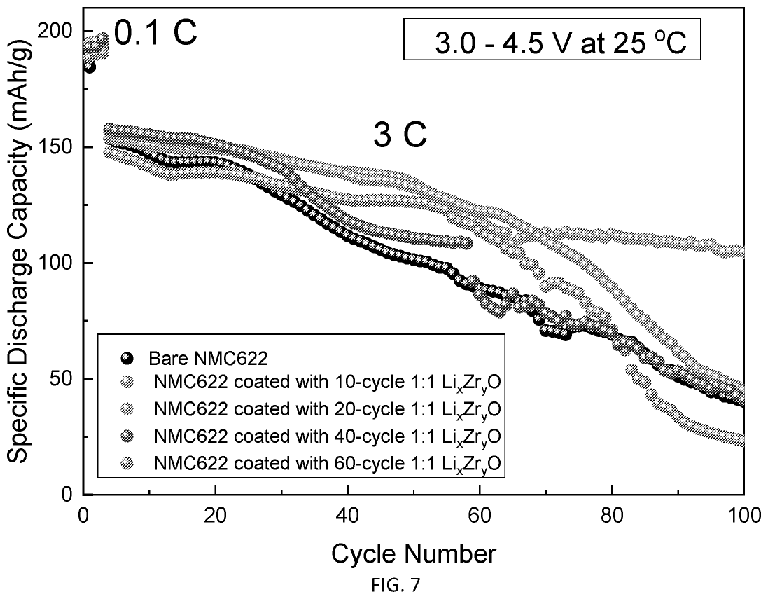

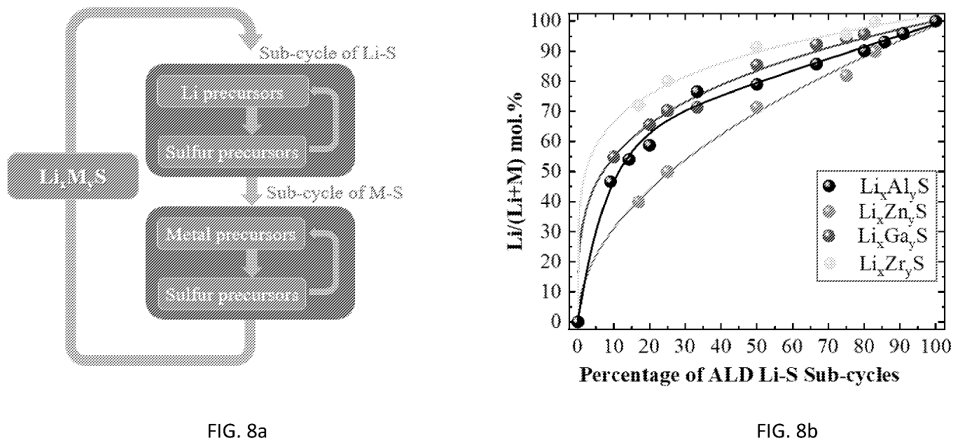

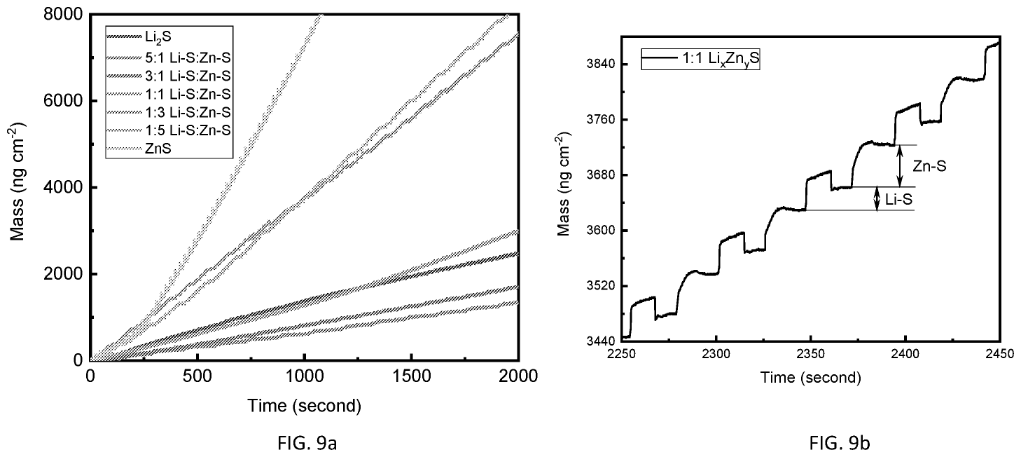

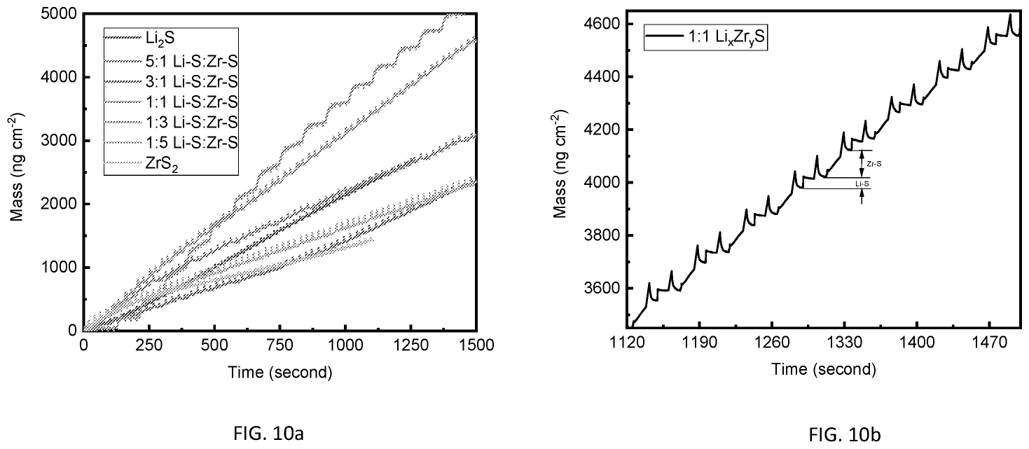

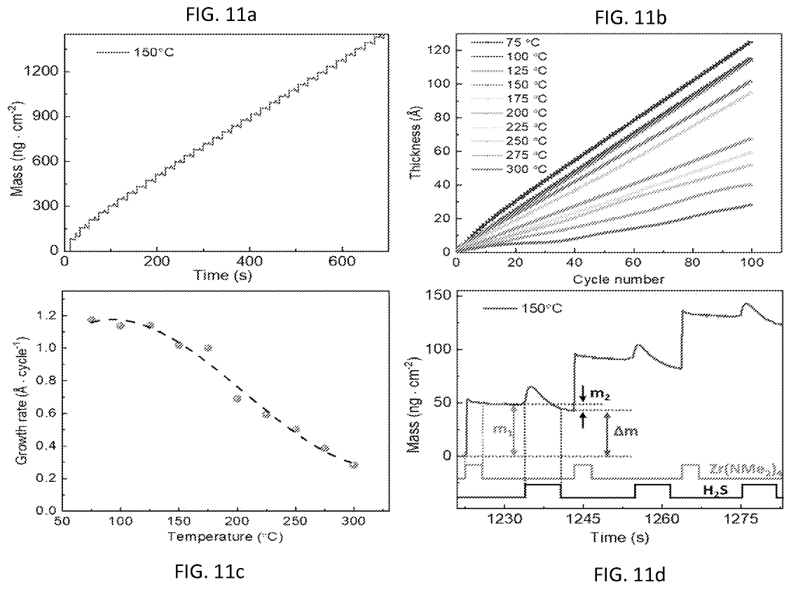

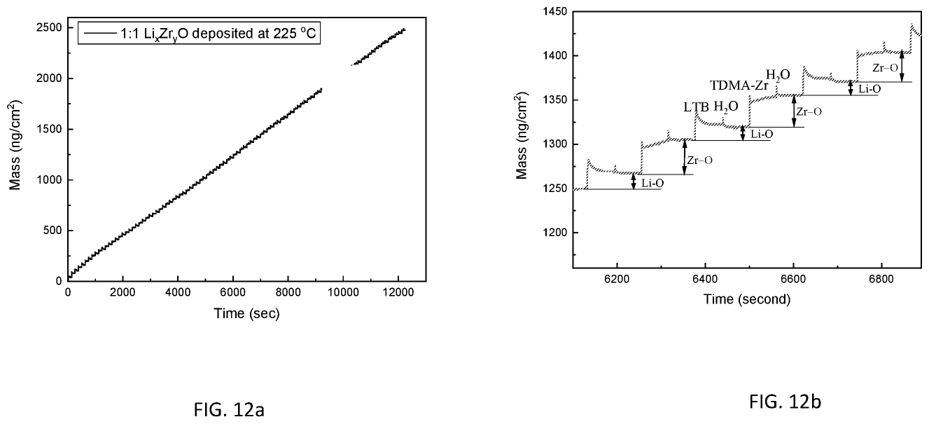

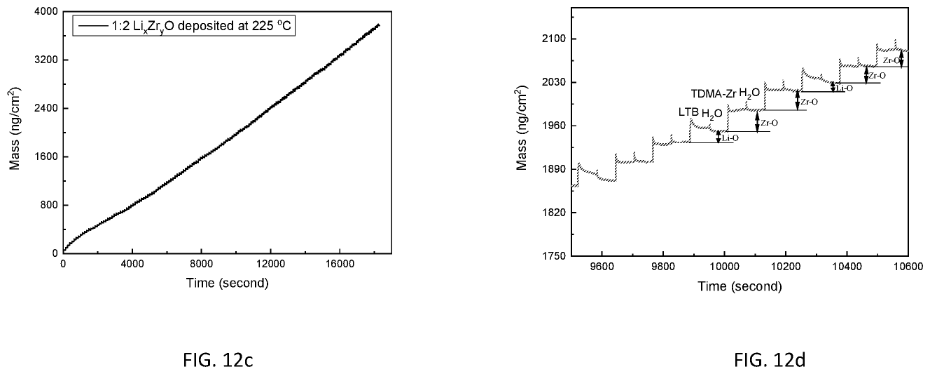

In addition to the coatings of LiₓAl_{y}S, we further investigated the effects of two new ALD coatings Li₂S (FIG. 6) and LiₓZr_{y}O (FIG. 7). They both exhibited positive effects in improving the performance of NMC811 and NMC622 cathodes, but they are limited to a thin coating thickness for the best performance of NMC cathodes. This should be due to their low ionic conductivity. Inspired by the exceptional ionic conductivity of LiₓAl_{y}S, we further three new ALD processes for depositing LiₓZn_{y}S, LiₓGa_{y}S, and LiₓZr_{y}S. The ALD strategy for these ternary lithium metal sulfides (LiₓM_{y}S, M=Al, Zn, Ga, and Zr) is illustrated in FIG. 8a, and we also illustrate in FIG. 8b for the tunable composition of these LiₓM_{y}S. The data in FIG. 8b were based on the measurements of quartz crystal microbalance (QCM). FIGS. 9a and 9b show the QCM data by varying the sub-cycle ratio of Li—S:ZnS, showing that the composition of LiₓZn_{y}S is tunable by changing the sub-cycle ratio of Li—S:ZnS. In all the cases, the growth of LiₓZn_{y}S is linear. FIGS. 10a and 10b show the QCM data by varying the sub-cycle ratio of Li—S:ZrS, showing that the composition of LiₓZr_{y}S is tunable by changing the sub-cycle ratio of Li—S:ZrS. In all the cases, the growth of LiₓZr_{y}S is linear. FIG. 11 shows the data of a new ALD process of ZrS₂ we developed and this ALD ZrS₂ process is essential for us to develop the ALD LiₓZr_{y}S in FIG. 10. FIG. 12 shows the QCM data for the new ALD process of LiₓZr_{y}O at different sub-cycle ratios of Li—O:Zr—O.

### NMC811 Electrode Fabrication, Deposition of ALD Coatings, and Electrochemical Evaluations

Ni-rich NMC electrodes will be fabricated using a commercial micron-sized Ni-rich NMC powder (MSE Supplies LLC). Using a Thinky AR-100 mixer, NMC powders will be mixed with a Super P carbon black (MTI Corporation) and a polyvinylidene fluoride binder (PVDF, Sigma-Aldrich) in a weight ratio of 8:1:1 in N-methyl-2-pyrrolidone (NMP, Sigma-Aldrich) at 2000 rpm for 30 min. The resultant slurry will be cast onto an aluminum foil and made into electrode laminates using a doctor blade with a controlled thickness of 200 m. The received NMC electrodes will be dried in air for 24 hours and then transferred into a vacuum heater to cure the PVDF binder at 100° C. for 10 hours. The fabricated NMC electrodes will have a NMC loading of 8-10 mg/cm². Subsequently, the fabricated NMC cathodes will be deposited with a conformal layer of a lithium-containing coating with controllable thicknesses using an ALD system (Savannah S200, Ultratech Inc.). Bare NMC electrodes and the ALD-coated NMC electrodes will be comparatively studied for their electrochemical performance in CR2032 coin cells at same conditions. A Celgard 2325 membrane will be used as the separator placed between the cathode and anode. The electrolyte will be 1.2 M LiPF6 in a mixture of ethylene carbonate (EC) and ethyl methyl carbonate (EMC) (3/7, wt/wt) (Panax Etec Co.). All the cells will be assembled in a glovebox with both moisture and oxygen below 1 ppm. The bare and ALD-coated NMC electrodes are thoroughly tested (using two Neware battery cyclers with 144 channels) to explore the beneficial effects of the ALD coatings in different voltage ranges and different temperatures. Additionally, we investigate the evolution of both impedance and cyclic voltammetry (CV) of the bare and ALD-coated cells with charge-discharge cycles using an electrochemical impedance spectroscopy (EIS, BioLogic SP-200). We conducted analyses on voltage drop through normalizing charge-discharge profiles and on the evolutions of differential capacity (i.e., (dQ/dV)−V) profiles in order to obtain the effects of the sup-LAS coating on stabilizing the NMC structures.

The ALD Li₂S coating was conducted using lithium tert-butoxide (LTB) and H₂S as precursors at 150° C., but the deposition temperature can range from 150° C. to 300° C. The ALD LiₓAl_{y}S used the precursor pair of LTB and H₂S for ALD Li—S and the precursor pair of tris(dimethylamido)aluminum (TDMA-Al, Al₂(NMe₂)₆, where Me=CH₃) and H₂S for ALD Al—S. The ALD LiₓZn_{y}S used the precursor pair of LTB and H₂S for ALD Li—S and the precursor pair of diethylzinc (DEZ, C₂H₅) and H₂S for ALD Zn—S. The ALD LiₓGa_{y}S used the precursor pair of LTB and H₂S for ALD Li—S and the precursor pair of hexakis(dimethylamido)digallium (Ga₂(NMe₂)₆, Me=CH₃) and H₂S for ALD Ga—S. The ALD LiₓZr_{y}S used the precursor pair of LTB and H₂S for ALD Li—S and the precursor pair of tetrakis(dimethylamido)zirconium (TDMA-Zr, Zr(NMe₂)₄, Me=CH₃) and H₂S for ALD Zr—S. The ALD LiₓZr_{y}O used the precursor pair of LTB and H₂O for ALD Li—O and the precursor pair of tetrakis(dimethylamido)zirconium (TDMA-Zr, Zr(NMe₂)₄, Me=CH₃) and H₂O for ALD Zr—O.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. An electrode comprising:
nickel-rich layered oxide; and
a sulfide-based or oxide-based coating over the nickel-rich layered oxide, the sulfide- or oxide-based coating having an ionic conductivity greater than 1×10⁻⁴ S/cm at room temperature.

2. The electrode of claim 1, wherein the ionic conductivity is at least 1×10⁻³ S/cm at room temperature.

3. The electrode of claim 1, wherein the sulfide-based coating comprises a ternary sulfide, the ternary sulfide including lithium and aluminum, lithium and zinc, lithium and gallium, or lithium and zirconium.

4. The electrode of claim 1, wherein the sulfide-based coating has a uniform thickness.

5. The electrode of claim 4, wherein the thickness is from 1 nm to 10 nm.

6. The electrode of claim 1, wherein the nickel-rich layered oxide is of the formula LiNi_{1-x-y}MnₓCo_{y}O₂, wherein 1−x−y≥0.6.

7. The electrode of claim 6, wherein 1−x−y>0.7.

8. The electrode of claim 6, wherein 1−x−y≥0.8.

9. The electrode of claim 3, wherein the ternary sulfide is of the formula LiₚMₙ₍₂₋ₚ₎S, wherein 0<p≤2, 0.25≤n≤0.5.

10. The electrode of claim 1, wherein the sulfide-based coating is deposited by atomic layer deposition.

11. An electrode comprising:
nickel-rich layered oxide; and
a ternary sulfide-based coating over the nickel-rich layered oxide.

12. The electrode of claim 11, wherein the ternary sulfide-based layer includes lithium and aluminum, lithium and zinc, lithium and gallium, or lithium and zirconium.

13. The electrode of claim 11, wherein the ternary sulfide is of the formula LiₚMₙ₍₂₋ₚ₎S, wherein 0<p≤2, 0.25≤n≤0.5.

14. The electrode of claim 11, wherein the ternary sulfide based layer has ionic conductivity greater than 1×10⁻⁴ S/cm at room temperature.

15. The electrode of claim 14, wherein the ionic conductivity is at least 1×10⁻³ S/cm at room temperature.

16. The electrode of claim 11, wherein the ternary sulfide-based coating has thickness of 1 nm to 10 nm.

17. The electrode of claim 11, wherein the nickel-rich layered oxide is of the formula LiNi_{1-x-y}MnₓCo_{y}O₂, wherein 1−x−y≥0.6.

18. The electrode of claim 17, wherein 1−x−y>0.7.

19. The electrode of claim 17, wherein 1−x−y≥0.8.

20. A battery comprising:
an anode; and
a cathode, the cathode comprising nickel-rich layered oxide, and a sulfide-based or oxide-based coating over the nickel-rich layered oxide, the sulfide- or oxide-based coating having an ionic conductivity greater than 1×10⁻⁴ S/cm at room temperature.

21-32. (canceled)
